(19) United States
(12) Patent Application Publication
(10) Pub. No.: US 2026/0227726 A1
(43) Pub. Date: Aug. 6, 2026

(54) FIXING DEVICE AND IMAGE FORMING APPARATUS

(71) Applicants: Seiji SAITOH, Chiba (JP); Yoshikuni SASAKI, Kanagawa (JP)

(72) Inventors: Seiji SAITOH, Chiba (JP); Yoshikuni SASAKI, Kanagawa (JP)

(73) Assignee: ETRIA CO., LTD., Yokohama, Kanagawa (JP)

(21) Appl. No.: 19/411,899

(22) Filed: Dec. 8, 2025

(30) Foreign Application Priority Data
Feb. 3, 2025 (JP) 2025-016103

(51) Int. Cl. G03G 15/20

(52) U.S. Cl. CPC G03G 15/2017; G03G 15/205; G03G 15/2064; G03G 2215/2035

(57) ABSTRACT

A fixing device includes a fixing belt that is endless and rotates. A pressure rotator is disposed opposite the fixing belt and rotates. A heater is disposed within a loop formed by the fixing belt and heats the fixing belt. A nip formation pad is disposed opposite the pressure rotator via the fixing belt to form a nip between the fixing belt and the pressure rotator. The nip formation pad includes a vapor chamber. A reinforcement is disposed within the loop formed by the fixing belt. The reinforcement supports the nip formation pad. A reflection plate is interposed between the heater and the reinforcement and reflects heat from the heater toward the fixing belt. A thermal conductor couples the reflection plate with the vapor chamber of the nip formation pad.

### CROSS-REFERENCE TO RELATED APPLICATION

This patent application is based on and claims priority pursuant to 35 U.S.C. § 119(a) to Japanese Patent Application No. 2025-016103, filed on Feb. 3, 2025, in the Japan Patent Office, the entire disclosure of which is hereby incorporated by reference herein.

### BACKGROUND

### Technical Field

The present disclosure relates to a fixing device and an image forming apparatus, and more particularly, to a fixing device and an image forming apparatus incorporating the fixing device.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data by electrophotography.

Such image forming apparatuses include a fixing device including a nip formation pad that forms a fixing nip between a fixing rotator and a pressure rotator. As a recording medium bearing an image is conveyed through the fixing nip, the fixing rotator and the pressure rotator fix the image on the recording medium.

### SUMMARY

The present disclosure described herein provides a fixing device that includes a fixing belt that is endless and rotates. A pressure rotator is disposed opposite the fixing belt and rotates. A heater is disposed within a loop formed by the fixing belt and heats the fixing belt. A nip formation pad is disposed opposite the pressure rotator via the fixing belt to form a nip between the fixing belt and the pressure rotator. The nip formation pad includes a vapor chamber. A reinforcement is disposed within the loop formed by the fixing belt. The reinforcement supports the nip formation pad. A reflection plate is interposed between the heater and the reinforcement and reflects heat from the heater toward the fixing belt. A thermal conductor couples the reflection plate with the vapor chamber of the nip formation pad.

The present disclosure described herein further provides a fixing device that includes fixing means for being rotated, pressing means for being rotated, heating means for heating the fixing means, and nip forming means for forming a nip between the fixing means and the pressing means. The nip forming means includes a vapor chamber. The fixing device further includes reinforcing means for supporting the nip forming means, reflecting means for reflecting heat from the heating means toward the fixing means, and thermal conducting means for conducting heat from the reflecting means to the vapor chamber of the nip forming means.

The present disclosure described herein further provides an image forming apparatus that includes an image forming device that forms an image and the above-described fixing device that fixes the image on a recording medium.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a cross-sectional view of an image forming apparatus according to an embodiment of the present disclosure, illustrating a construction thereof, as one example;

FIG. 2 is a diagram of a fixing device according to an embodiment of the present disclosure, that is incorporated in the image forming apparatus depicted in FIG. 1, as one example;

FIG. 3 is a diagram of the fixing device depicted in FIG. 2, illustrating a part of the fixing device;

FIG. 4 is a diagram of a vapor chamber incorporated in the fixing device depicted in FIG. 2;

FIG. 5 is a perspective view of the vapor chamber depicted in FIG. 4;

FIG. 6 is a schematic cross-sectional view of a fixing device incorporating a heat pipe;

FIG. 7 is a schematic cross-sectional view of a fixing device incorporating a component that couples and separates a reinforcement with respect to a nip formation pad thermally;

FIG. 8 is a schematic cross-sectional view of the fixing device depicted in FIG. 2;

FIG. 9 is a partial cross-sectional view of the fixing device depicted in FIG. 8;

FIG. 10 is a partial cross-sectional view of a fixing device according to another embodiment of the present disclosure, that is installable in the image forming apparatus depicted in FIG. 1;

FIG. 11 is a schematic cross-sectional view of a fixing device according to yet another embodiment of the present disclosure, that is installable in the image forming apparatus depicted in FIG. 1;

FIG. 12 is a cross-sectional view of the fixing device depicted in FIG. 11;

FIG. 13 is a partial perspective view of the fixing device depicted in FIG. 12;

FIG. 14 is a partial perspective view of the fixing device depicted in FIG. 13;

FIG. 15 is a cross-sectional view of a fixing device according to yet another embodiment of the present disclosure, that is installable in the image forming apparatus depicted in FIG. 1;

FIG. 16 is a cross-sectional view of a fixing device according to yet another embodiment of the present disclosure, that is installable in the image forming apparatus depicted in FIG. 1;

FIG. 17 is a cross-sectional view of a fixing device according to yet another embodiment of the present disclosure, that is installable in the image forming apparatus depicted in FIG. 1;

FIG. 18 is a partially exploded view of a fixing device according to yet another embodiment of the present disclosure, that is installable in the image forming apparatus depicted in FIG. 1;

FIG. 19 is a partial perspective view of a fixing device according to yet another embodiment of the present disclosure, that is installable in the image forming apparatus depicted in FIG. 1; and

FIG. 20 is a partial perspective view of a fixing device according to yet another embodiment of the present disclosure, that is installable in the image forming apparatus depicted in FIG. 1.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Referring to attached drawings, a detailed description is provided of a construction of a fixing device and an image forming apparatus according to an embodiment of the present disclosure.

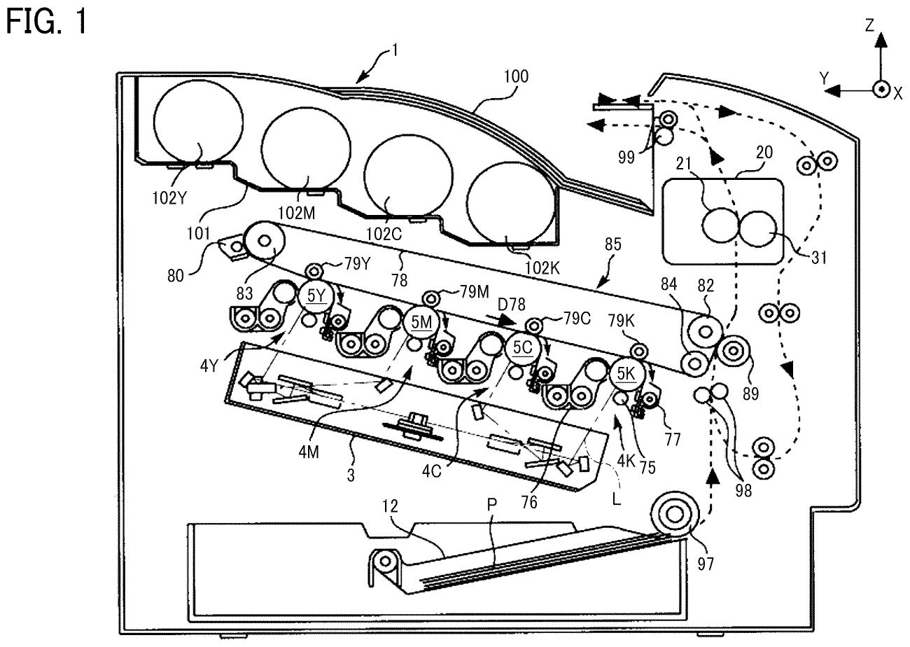

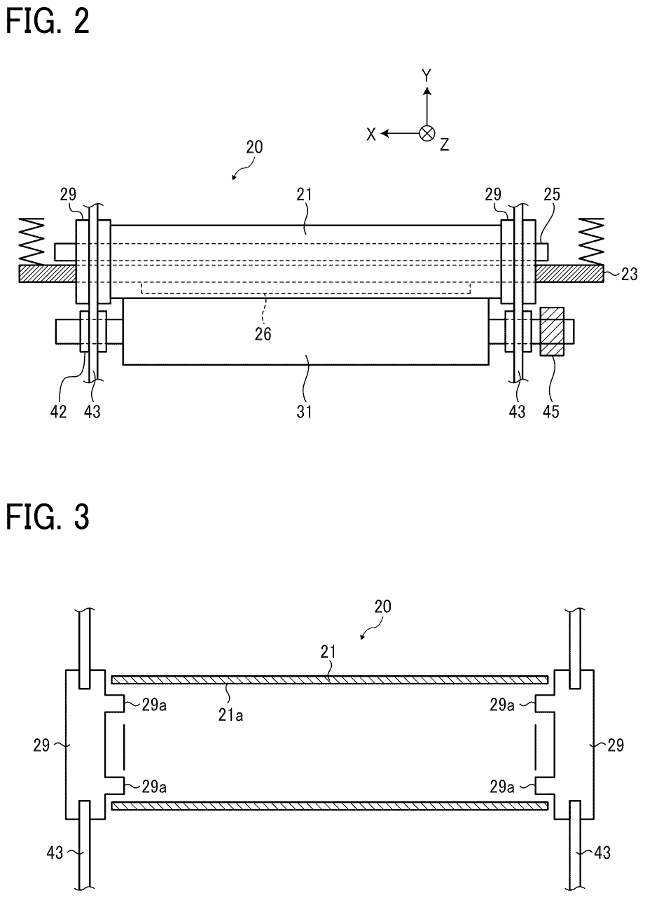

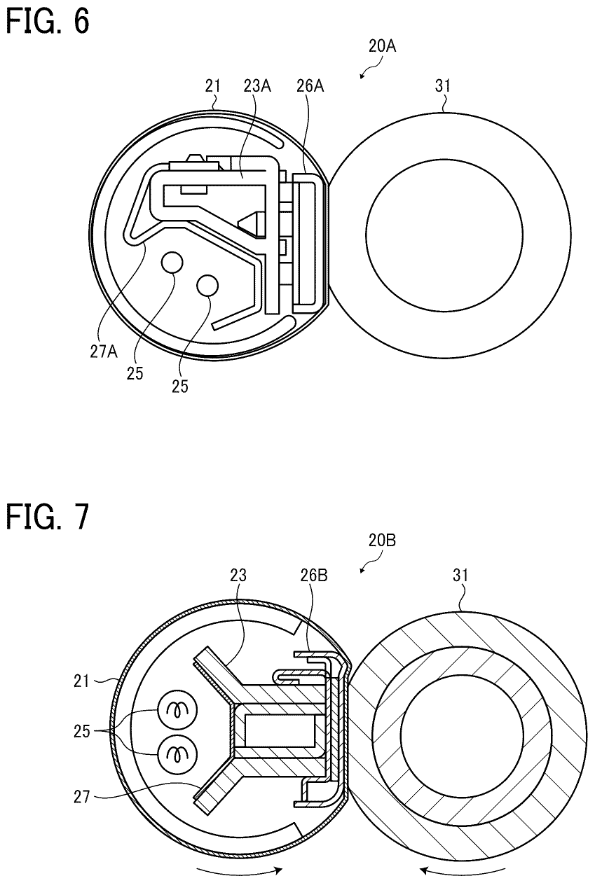

FIG. 1 is a cross-sectional view of the image forming apparatus according to the embodiment, illustrating the construction thereof as one example. FIGS. 2 to 5 illustrate the fixing device incorporated in the image forming apparatus according to the embodiment as one example. Each of FIGS. 6 to 11 is a schematic cross-sectional view of a fixing device incorporated in the image forming apparatus depicted in FIG. 1 as one example.

Referring to FIG. 1, a description is provided of an entire construction and operation of an image forming apparatus 1 according to an embodiment of the present disclosure.

As illustrated in FIG. 1, the image forming apparatus 1 according to the embodiment is a tandem color printer. The image forming apparatus 1 includes a bottle holder 101, four toner bottles 102Y, 102M, 102C, and 102K, an intermediate transfer unit 85, and four image forming devices 4Y, 4M, 4C, and 4K. The bottle holder 101 is disposed in an upper portion of a body of the image forming apparatus 1. The bottle holder 101 holds the four toner bottles 102Y, 102M, 102C, and 102K that contain yellow, magenta, cyan, and black toners, respectively. The toner bottles 102Y, 102M, 102C, and 102K are detachably attached to the bottle holder 101 for replacement. The intermediate transfer unit 85 is disposed below the bottle holder 101. The intermediate transfer unit 85 includes an intermediate transfer belt 78 that is disposed opposite the image forming devices 4Y, 4M, 4C, and 4K that are arranged along the intermediate transfer belt 78 and form yellow, magenta, cyan, and black toner images, respectively.

The image forming devices 4Y, 4M, 4C, and 4K include photoconductive drums 5Y, 5M, 5C, and 5K, respectively. Each of the image forming devices 4Y, 4M, 4C, and 4K further includes a charger 75, a developing device 76, a cleaner 77, a discharger, and the like that surround each of the photoconductive drums 5Y, 5M, 5C, and 5K. Image forming processes (e.g., a charging process, an exposure process, a developing process, a primary transfer process, and a cleaning process) are performed on a surface of each of the photoconductive drums 5Y, 5M, 5C, and 5K, forming yellow, magenta, cyan, and black toner images on the surfaces of the photoconductive drums 5Y, 5M, 5C, and 5K, respectively.

The image forming apparatus 1 further includes an exposure device 3 and a motor that drives and rotates the photoconductive drums 5Y, 5M, 5C, and 5K clockwise in FIG. 1. When the surfaces of the photoconductive drums 5Y, 5M, 5C, and 5K reach charging positions disposed opposite the chargers 75, the chargers 75 uniformly charge the surfaces of the photoconductive drums 5Y, 5M, 5C, and 5K, respectively, in the charging process. Thereafter, charged portions on the surfaces of the photoconductive drums 5Y, 5M, 5C, and 5K reach irradiation positions where the exposure device 3 irradiates the photoconductive drums 5Y, 5M, 5C, and 5K with laser beams L, respectively. The laser beams L scan and expose the surfaces of the photoconductive drums 5Y, 5M, 5C, and 5K, forming electrostatic latent images according to yellow, magenta, cyan, and black image data, respectively, in the exposure process.

Thereafter, when exposed portions on the surfaces of the photoconductive drums 5Y, 5M, 5C, and 5K reach developing positions disposed opposite the developing devices 76, the developing devices 76 develop the electrostatic latent images into the yellow, magenta, cyan, and black toner images, respectively, in the developing process. The image forming apparatus 1 further includes primary transfer bias rollers 79Y, 79M, 79C, and 79K. Thereafter, when developed portions on the surfaces of the photoconductive drums 5Y, 5M, 5C, and 5K reach primary transfer positions disposed opposite the primary transfer bias rollers 79Y, 79M, 79C, and 79K via the intermediate transfer belt 78, the primary transfer bias rollers 79Y, 79M, 79C, and 79K primarily transfer the yellow, magenta cyan, and black toner images formed on the photoconductive drums 5Y, 5M, 5C, and 5K, respectively, onto the intermediate transfer belt 78 in the primary transfer process. The surfaces of the photoconductive drums 5Y, 5M, 5C, and 5K, respectively, bear residual toner in a slight amount that is failed to be transferred onto the intermediate transfer belt 78.

Thereafter, when transferred portions on the surfaces of the photoconductive drums 5Y, 5M, 5C, and 5K reach cleaning positions disposed opposite the cleaners 77, respectively, cleaning blades of the cleaners 77 mechanically remove and collect the residual toner from the photoconductive drums 5Y, 5M, 5C, and 5K in the cleaning process. Thereafter, when cleaned portions on the surfaces of the photoconductive drums 5Y, 5M, 5C, and 5K reach discharging positions disposed opposite the dischargers, respectively, the dischargers remove a residual electric potential on the photoconductive drums 5Y, 5M, 5C, and 5K. Thus, a series of image forming processes performed on the photoconductive drums 5Y, 5M, 5C, and 5K finishes.

Thereafter, the primary transfer bias rollers 79Y, 79M, 79C, and 79K primarily transfer the yellow, magenta, cyan, and black toner images, that are developed in the developing process, from the photoconductive drums 5Y, 5M, 5C, and 5K onto the intermediate transfer belt 78 such that the yellow, magenta, cyan, and black toner images are superimposed on a surface of the intermediate transfer belt 78. Thus, a color toner image is formed on the intermediate transfer belt 78. The intermediate transfer unit 85 includes the intermediate transfer belt 78, the four primary transfer bias rollers 79Y, 79M, 79C, and 79K, a secondary transfer backup roller 82, a cleaning backup roller 83, a tension roller 84, and an intermediate transfer belt cleaner 80. The intermediate transfer belt 78 is stretched across and supported by three rollers, that is, the secondary transfer backup roller 82, the cleaning backup roller 83, and the tension roller 84. One of the three rollers, that is, the secondary transfer backup roller 82, drives and rotates the intermediate transfer belt 78 serving as an endless belt in a direction indicated by arrow in FIG. 1, that is, a rotation direction D78.

The four primary transfer bias rollers 79Y, 79M, 79C, and 79K and the photoconductive drums 5Y, 5M, 5C, and 5K, respectively, sandwich the intermediate transfer belt 78 to form primary transfer nips therebetween. The primary transfer bias rollers 79Y, 79M, 79C, and 79K are applied with transfer biases having polarities opposite to polarities of the yellow, magenta, cyan, and black toners, respectively. The intermediate transfer belt 78 rotates in the rotation direction D78 and passes through the primary transfer nips formed by the primary transfer bias rollers 79Y, 79M, 79C, and 79K successively. Accordingly, the primary transfer bias rollers 79Y, 79M, 79C, and 79K primarily transfer the yellow, magenta, cyan, and black toner images formed on the photoconductive drums 5Y, 5M, 5C, and 5K, respectively, onto the intermediate transfer belt 78 such that the yellow, magenta, cyan, and black toner images are superimposed on the intermediate transfer belt 78.

The image forming apparatus 1 further includes a secondary transfer roller 89. The yellow, magenta, cyan, and black toner images superimposed on the intermediate transfer belt 78 reach a secondary transfer position disposed opposite the secondary transfer roller 89. At the secondary transfer position, the secondary transfer backup roller 82 and the secondary transfer roller 89 sandwich the intermediate transfer belt 78 to form a secondary transfer nip between the secondary transfer roller 89 and the intermediate transfer belt 78. The secondary transfer roller 89 secondarily transfers the yellow, magenta, cyan, and black toner images superimposed on the intermediate transfer belt 78 onto a sheet P serving as a recording medium conveyed through the secondary transfer nip. The intermediate transfer belt 78 bears residual toner failed to be transferred onto the sheet P. Thereafter, the residual toner on the intermediate transfer belt 78 reaches a cleaning position disposed opposite the intermediate transfer belt cleaner 80. At the cleaning position, the intermediate transfer belt cleaner 80 collects the residual toner from the intermediate transfer belt 78. Thus, a series of transfer processes performed on the intermediate transfer belt 78 finishes.

The image forming apparatus 1 further includes a sheet feeder 12, a feed roller 97, and a registration roller pair 98. The sheet P conveyed to the secondary transfer nip is conveyed from the sheet feeder 12 disposed in a lower portion of the body of the image forming apparatus 1 through the feed roller 97, the registration roller pair 98 (e.g., a timing roller pair), and the like. For example, the sheet feeder 12 loads a plurality of sheets P stacked therein. As the feed roller 97 is driven and rotated counterclockwise in FIG. 1, the feed roller 97 feeds an uppermost sheet P of the plurality of sheets P toward a roller nip formed between two rollers of the registration roller pair 98.

The registration roller pair 98 that interrupts rotation temporarily halts the sheet P conveyed to the registration roller pair 98 at the roller nip thereof. The registration roller pair 98 resumes rotation and conveys the sheet P to the secondary transfer nip at a time when the color toner image formed on the intermediate transfer belt 78 reaches the secondary transfer nip. The secondary transfer roller 89 secondarily transfers the color toner image from the intermediate transfer belt 78 onto the sheet P.

The image forming apparatus 1 further includes a fixing device 20, an output roller pair 99, and an output tray 100 (e.g., a stack portion). Thereafter, the secondary transfer roller 89 conveys the sheet P transferred with the color toner image at the secondary transfer nip to the fixing device 20. The fixing device 20 includes a fixing belt 21 and a pressure roller 31. The fixing belt 21 and the pressure roller 31 fix the color toner image transferred on a surface of the sheet P under heat and pressure in a fixing process. Thereafter, the sheet P is conveyed through a roller nip formed between two rollers of the output roller pair 99 and ejected onto an outside of the image forming apparatus 1. The sheets P ejected by the output roller pair 99 onto the outside of the image forming apparatus 1 are stacked on the output tray 100 successively as outputs. Thus, a series of image forming processes performed by the image forming apparatus 1 finishes.

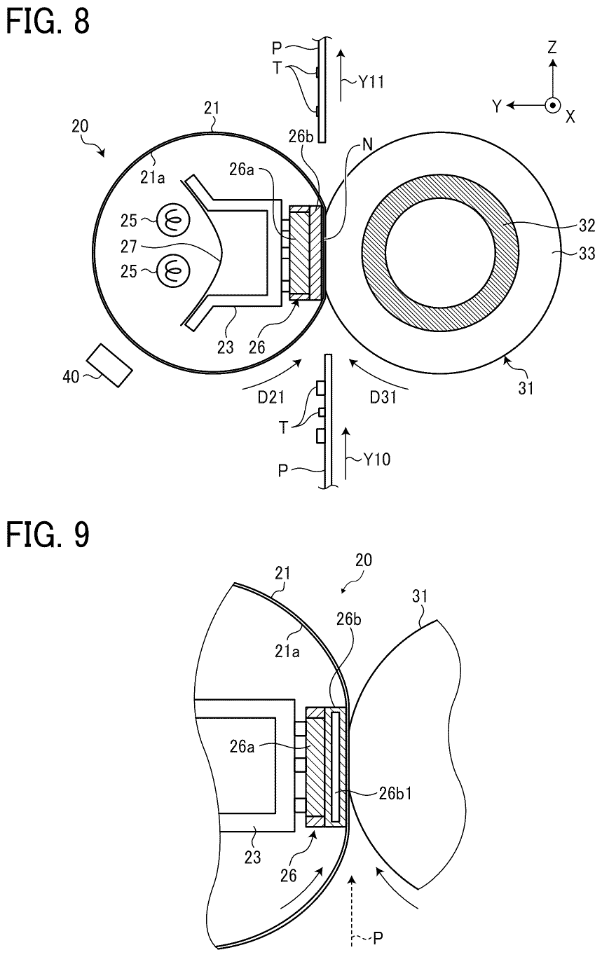

Referring to FIG. 8, a description is provided of a construction and operation of the fixing device 20 incorporated in the image forming apparatus 1 in detail.

The fixing device 20 conveys the sheet P bearing an unfixed toner image T under heat. As illustrated in FIGS. 2, 3, 8, and the like, the fixing device 20 includes the fixing belt 21 serving as a belt, a nip formation pad 26, a reinforcement 23, heaters 25 serving as heat sources, a reflection plate 27, the pressure roller 31 serving as a pressure rotator, and a temperature sensor 40 serving as a temperature detector.

The fixing belt 21 is an endless belt that contacts an outer circumferential face of the pressure roller 31 and rotates in accordance with rotation of the pressure roller 31. The fixing belt 21 is the endless belt that is thin and flexible. As the pressure roller 31 rotates in a rotation direction D31, the pressure roller 31 drives and rotates the fixing belt 21 counterclockwise in FIG. 8 in a rotation direction D21. The fixing belt 21 is one example of an endless fixing belt that is rotatable. The fixing belt 21 includes a base layer, an elastic layer disposed on the base layer, and a release layer disposed on the elastic layer. The base layer defines an inner circumferential face 21a of the fixing belt 21 as a sliding contact surface that slides over the nip formation pad 26. The fixing belt 21 has a total thickness not greater than 1 mm. The base layer of the fixing belt 21 has a layer thickness in a range of from 30 μm to 50 μm. The base layer is made of a metal material such as nickel and stainless steel or a resin material such as polyimide. The elastic layer of the fixing belt 21 has a layer thickness in a range of from 100 μm to 300 μm and is made of a rubber material such as silicone rubber, silicone rubber foam, and fluororubber. The elastic layer prevents slight surface asperities from being produced on a surface of the fixing belt 21 at a fixing nip N formed between the fixing belt 21 and the pressure roller 31. Thus, heat is conducted from the fixing belt 21 to the toner image T on the sheet P evenly, suppressing formation of an orange peel image. The release layer of the fixing belt 21 has a layer thickness in a range of from 5 μm to 50 μm. The release layer is made of perfluoroalkoxy alkane (PFA), polytetrafluoroethylene (PTFE), polyimide, polyetherimide, polyether sulfone (PES), or the like. The release layer facilitates separation and peeling of toner of the toner image T from the fixing belt 21.

The nip formation pad 26, the heaters 25, the reinforcement 23, the reflection plate 27, and the like are disposed within a loop formed by the fixing belt 21 and disposed opposite the inner circumferential face 21a of the fixing belt 21. The nip formation pad 26, that is disposed within the loop formed by the fixing belt 21 and disposed opposite the inner circumferential face 21a of the fixing belt 21, presses against the pressure roller 31 via the fixing belt 21, thus forming the nip (e.g., the fixing nip N) between the fixing belt 21 and the pressure roller 31, through which the sheet P is conveyed. The pressure roller 31 is one example of a pressure roller that is rotatably pressed against the fixing belt 21. The inner circumferential face 21a of the fixing belt 21 slides over the nip formation pad 26. The nip formation pad 26 presses against the pressure roller 31 via the fixing belt 21 to form the fixing nip N between the fixing belt 21 and the pressure roller 31. The sheet P is conveyed through the fixing nip N. The nip formation pad 26 includes a vapor chamber 26b that is disposed opposite the fixing nip N. The nip formation pad 26 is one example of a nip formation pad that is disposed within the loop formed by the fixing belt 21, is disposed opposite the pressure roller 31 to form the fixing nip N between the fixing belt 21 and the pressure roller 31, and includes the vapor chamber 26b.

The heaters 25 serving as heating means disposed within the loop formed by the fixing belt 21 heat the fixing belt 21 directly with radiant heat. The heaters 25 serving as the heating means heat the fixing belt 21 to heat the sheet P. Each of the heaters 25 is one example of a heater that is disposed within the loop formed by the fixing belt 21 and heats the fixing belt 21. The heaters 25 serving as the heating means heat the fixing belt 21 in a heating region in a circumferential direction of the fixing belt 21, that is other than the fixing nip N. For example, each of the heaters 25 serving as the heating means is a halogen heater or a carbon heater. As illustrated in FIG. 2, the fixing device 20 further includes side plates 43 to which both lateral ends of each of the heaters 25 in a longitudinal direction thereof are secured, respectively. The image forming apparatus 1 further includes a controller that controls output to the heaters 25 serving as the heating means. Thus, the heaters 25 heat the fixing belt 21 mainly in the heating region that is other than the fixing nip N and is disposed opposite the heaters 25 with radiant heat. The fixing belt 21 heated by the heaters 25 conducts heat from an outer circumferential face of the fixing belt 21 to the toner image T on the sheet P. The temperature sensor 40 serving as the temperature detector is a thermopile, a thermistor, or the like that is disposed opposite the outer circumferential face of the fixing belt 21. The controller controls output to the heaters 25 based on a temperature of the outer circumferential face of the fixing belt 21, that is detected by the temperature sensor 40. Such control of output to the heaters 25 adjusts a temperature, that is, a fixing temperature, of the fixing belt 21 to a desired temperature.

According to the embodiment, the two heaters 25 serving as the heating means are disposed opposite the inner circumferential face 21a of the fixing belt 21. Alternatively, a single heater 25 or three or more heaters 25 may be disposed opposite the inner circumferential face 21a of the fixing belt 21. A position of the heaters 25 and a shape of the reinforcement 23 described below are not limited to a position and a shape depicted in FIG. 8. For example, the heaters 25 may be disposed opposite the fixing belt 21 at a position upstream from and in proximity to the fixing nip N in the rotation direction D21 of the fixing belt 21 compared to the position of the heaters 25 depicted in FIG. 8. Accordingly, the shape of the reinforcement 23 may be modified.

As described above, in the fixing device 20 according to the embodiment, the heaters 25 do not heat a part of the fixing belt 21 locally. The heaters 25 heat the fixing belt 21 across a relatively broad region of the fixing belt 21 in the circumferential direction thereof. Accordingly, even if the fixing belt 21 rotates at a high speed, the heaters 25 heat the fixing belt 21 sufficiently, suppressing faulty fixing. With the relatively simple construction of the fixing device 20, the heaters 25 heat the fixing belt 21 efficiently. Thus, the fixing device 20 shortens a warm-up time taken after the image forming apparatus 1 is powered on until the fixing device 20 is heated to a predetermined temperature and a first print time taken after the image forming apparatus 1 is powered on until the image forming apparatus 1 outputs a first sheet P bearing a toner image T. Additionally, the fixing device 20 is downsized. In the fixing device 20 according to the embodiment, the heaters 25 serving as the heating means heat the fixing belt 21 directly, improving efficiency in heating the fixing belt 21. Additionally, the fixing device 20 is downsized at reduced costs.

As illustrated in FIG. 3, the fixing device 20 further includes two guides 29 that contact the inner circumferential face 21a of the fixing belt 21 at both lateral ends of the fixing belt 21 in a longitudinal direction thereof, respectively, guiding the fixing belt 21 and retaining a posture of the fixing belt 21 that is substantially tubular. For example, the two guides 29 are made of a heat-resistant resin material or the like. The guides 29 are fitted to the side plates 43 disposed at both lateral ends of the fixing device 20 in a longitudinal direction thereof, respectively. Each of the guides 29 includes a guide portion 29a and a stopper. The guide portion 29a supports the fixing belt 21 while the guide portion 29a retains the posture of the fixing belt 21 that is substantially tubular. The stopper restricts motion (e.g., skew) of the fixing belt 21 in the longitudinal direction thereof. In order to cause the nip formation pad 26 to form the fixing nip N, the guides 29 are disposed outboard from the fixing nip N in the circumferential direction of the fixing belt 21 and disposed opposite both lateral ends of the fixing belt 21 in the longitudinal direction thereof, respectively.

According to the embodiment, the guides 29 and the nip formation pad 26 contact the inner circumferential face 21a of the fixing belt 21. The guides 29 contact the inner circumferential face 21a of the fixing belt 21 loosely at both lateral ends of the fixing belt 21 in the longitudinal direction thereof, respectively. Specifically, the nip formation pad 26 is disposed opposite the inner circumferential face 21a of the fixing belt 21 via a slide sheet. No component (e.g., a belt guide) other than the guides 29 and the nip formation pad 26 contacts the inner circumferential face 21a of the fixing belt 21 and guides the fixing belt 21 that rotates. Thus, in order to improve efficiency in heating the fixing belt 21 and downsize the fixing device 20 at reduced costs, the fixing device 20 according to the embodiment eliminates a tubular heating member and employs the heaters 25 serving as the heating means that heat the fixing belt 21 directly without the tubular heating member interposed between the heaters 25 and the fixing belt 21.

According to the embodiment, as illustrated in FIG. 8, the reinforcement 23 is disposed within the loop formed by the fixing belt 21 and is disposed opposite the pressure roller 31 via the nip formation pad 26 and the fixing belt 21. The reinforcement 23 reinforces a mechanical strength of the nip formation pad 26 that forms the fixing nip N. The reinforcement 23 is fastened to the nip formation pad 26 with screws or the like. The reinforcement 23 is one example of a reinforcement that is disposed within the loop formed by the fixing belt 21 and supports the nip formation pad 26. As illustrated in FIG. 2, the reinforcement 23 is longer than the nip formation pad 26 in a longitudinal direction of the reinforcement 23. The side plates 43 of the fixing device 20 support the reinforcement 23 at both lateral ends of the reinforcement 23 in the longitudinal direction thereof, respectively, such that the reinforcement 23 is movable vertically in FIG. 2 and horizontally in FIG. 8. The reinforcement 23 is disposed opposite the pressure roller 31 via the nip formation pad 26 and the fixing belt 21. Hence, when the nip formation pad 26 receives pressure from the pressure roller 31 at the fixing nip N, the reinforcement 23 prevents the nip formation pad 26 from being deformed substantially. In order to achieve the above-described functions of the reinforcement 23, the reinforcement 23 is preferably made of a metal material having an enhanced mechanical strength such as stainless steel and iron.

According to the embodiment, the reflection plate 27 is stationarily interposed between the reinforcement 23 and the heaters 25. The reflection plate 27 is one example of a reflection plate that is interposed between the heaters 25 and the reinforcement 23 and reflects heat from the heaters 25 to the fixing belt 21. Accordingly, the reflection plate 27 reflects heat radiated from the heaters 25 toward the reinforcement 23, that is, infrared light that heats the reinforcement 23, to the fixing belt 21 to heat the fixing belt 21, improving efficiency in heating the fixing belt 21. The reflection plate 27 is made of aluminum, stainless steel, or the like. Alternatively, a part or an entirety of an opposed face of the reinforcement 23, that is disposed opposite the heaters 25, may be treated with mirror polishing or mounted with a thermal insulator. In this case also, the reinforcement 23 reflects heat similarly to the reflection plate 27.

As illustrated in FIG. 8, the pressure roller 31 serving as the pressure rotator includes a core metal 32 serving as a shaft and an elastic layer 33 disposed on the core metal 32. The fixing device 20 further includes a driving motor serving as a driver that drives and rotates the pressure roller 31 clockwise in FIG. 8 in a predetermined direction, that is, the rotation direction D31. The core metal 32 of the pressure roller 31 is hollow and is made of a metal material. The elastic layer 33 of the pressure roller 31 is made of silicone rubber foam, silicone rubber, fluororubber, or the like. Optionally, the pressure roller 31 may further include a release layer that coats the elastic layer 33. The release layer is thin and is made of PFA, PTFE, or the like. The pressure roller 31 is pressed against the fixing belt 21 to form the desired fixing nip N therebetween. As illustrated in FIG. 2, the fixing device 20 further includes a gear 45 that is mounted on the pressure roller 31 and meshes with a driving gear of the driving motor that drives and rotates the pressure roller 31 clockwise in FIG. 8 in the rotation direction D31. The fixing device 20 further includes bearings 42 through which the side plates 43 of the fixing device 20 rotatably support the pressure roller 31 at both lateral ends of the pressure roller 31 in a longitudinal direction thereof, respectively.

In a case that the elastic layer 33 of the pressure roller 31 is made of a sponge material such as silicone rubber foam, the elastic layer 33 decreases pressure exerted on the fixing nip N, reducing load applied to the nip formation pad 26. Additionally, the elastic layer 33 enhances thermal insulation of the pressure roller 31, suppressing conduction of heat from the fixing belt 21 to the pressure roller 31 and improving efficiency in heating the fixing belt 21.

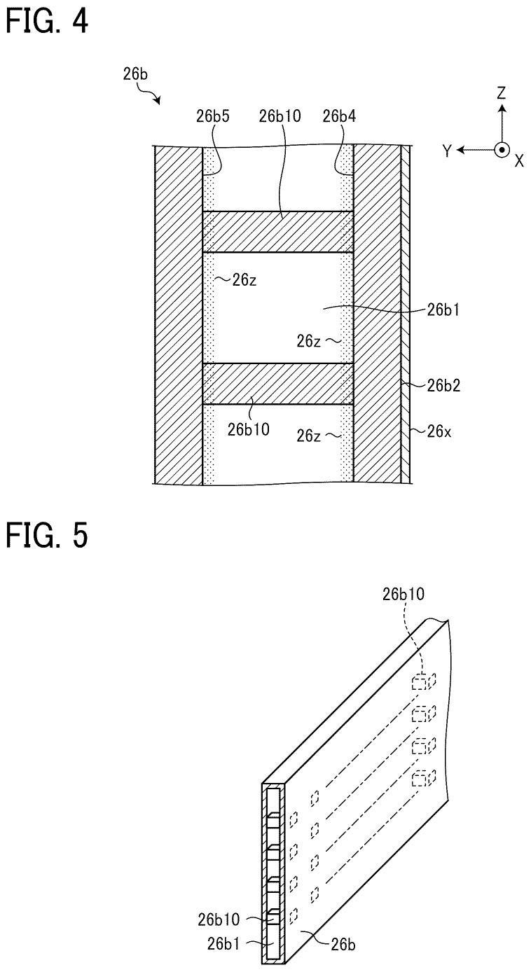

As illustrated in FIG. 9, the nip formation pad 26 over which the inner circumferential face 21a of the fixing belt 21 slides has an opposed face that is planar and is disposed opposite the pressure roller 31. The opposed face of the nip formation pad 26 is a slide-contact face 26b2 of the vapor chamber 26b described below with reference to FIG. 4. The slide-contact face 26b2 of the nip formation pad 26, that is, the opposed face disposed opposite the pressure roller 31, is a plane. Accordingly, the slide-contact face 26b2 causes the fixing nip N to be substantially parallel to an imaging side of the sheet P, that bears the toner image T, enhancing contact of the fixing belt 21 with the sheet P and therefore improving a fixing property of fixing the toner image T on the sheet P. Additionally, the fixing belt 21 has an increased curvature at an exit of the fixing nip N, facilitating separation of the sheet P ejected from the fixing nip N from the fixing belt 21.

Referring to FIGS. 1 and 8, a brief description is provided of regular operation of the fixing device 20 having the construction described above.

As a power switch disposed inside the body of the image forming apparatus 1 is turned on, a power supply supplies power to the heaters 25 and the driving motor starts driving and rotating the pressure roller 31 in the rotation direction D31 depicted in FIG. 8. Accordingly, the pressure roller 31 drives and rotates the fixing belt 21 in the rotation direction D21 depicted in FIG. 8 in accordance with rotation of the pressure roller 31 by friction between the pressure roller 31 and the fixing belt 21 at the fixing nip N. Thereafter, the sheet feeder 12 supplies a sheet P to the secondary transfer roller 89. The secondary transfer roller 89 secondarily transfers an unfixed color toner image T onto the sheet P. Thus, the sheet P bears the unfixed toner image T. The secondary transfer roller 89 and the intermediate transfer belt 78 convey the sheet P bearing the unfixed toner image T in a sheet conveyance direction Y10 depicted in FIG. 8 while a guide plate guides the sheet P. The sheet P enters the fixing nip N formed between the fixing belt 21 and the pressure roller 31 pressed against the fixing belt 21. Under heat from the fixing belt 21 heated by the heaters 25 and pressure applied by the pressure roller 31 pressed against the nip formation pad 26 reinforced by the reinforcement 23, the fixing belt 21 and the pressure roller 31 fix the toner image T on the surface of the sheet P. Thereafter, the sheet P ejected from the fixing nip N is conveyed in a sheet conveyance direction Y11.

A detailed description is provided of advantageous construction and operation of the fixing device 20 according to an embodiment of the present disclosure.

As described above with reference to FIG. 8 and the like, the fixing device 20 according to the embodiment includes the fixing belt 21 and the nip formation pad 26. The fixing belt 21 is the endless belt that is heated by the heaters 25 serving as the heating means and rotates counterclockwise in FIG. 8 in the predetermined rotation direction D21. The heaters 25 are disposed opposite the inner circumferential face 21a of the fixing belt 21. The nip formation pad 26 is disposed opposite the inner circumferential face 21a of the fixing belt 21. The nip formation pad 26 presses against the pressure roller 31 serving as the pressure rotator via the fixing belt 21, forming the nip (e.g., the fixing nip N) between the fixing belt 21 and the pressure roller 31. The sheet P is conveyed through the fixing nip N.

As illustrated in FIG. 9 and the like, the fixing device 20 according to the embodiment includes the nip formation pad 26 that includes the vapor chamber 26b over which the inner circumferential face 21a of the fixing belt 21 slides. For example, the nip formation pad 26 mainly includes a support 26a (e.g., a body of the nip formation pad 26) and the vapor chamber 26b.

The support 26a contacts a distanced face (e.g., an inner face) of the vapor chamber 26b, that is distanced farther from the nip (e.g., the fixing nip N) than a nip face of the vapor chamber 26b, that faces the fixing nip N. Thus, the support 26a supports the vapor chamber 26b. For example, the support 26a is disposed opposite the fixing nip N via the vapor chamber 26b. The support 26a has a rigidity that prevents substantial bending even when the support 26a receives pressure from the pressure roller 31. The support 26a is made of a resin material such as liquid crystal polymer (LCP), polyamide imide (PAI), polyether sulfone (PES), polyphenylene sulfide (PPS), polyether nitrile (PEN), and polyether ether ketone (PEEK). The support 26a supports the vapor chamber 26b and is supported by the reinforcement 23.

As illustrated in FIG. 4, the vapor chamber 26b includes a hollow portion 26b1 (e.g., a chamber) sealed with working fluid such as water. The vapor chamber 26b serves as a metallic, heat dissipating member that vaporizes and condenses the working fluid to transport heat instantly. The vapor chamber 26b further includes wicks 26z and inner walls 26b4 and 26b5. The wicks 26z are disposed in the hollow portion 26b1. The wicks 26z are mounted on substantially entire faces of the inner walls 26b4 and 26b5, respectively. The wicks 26z are substantially made of gauze containing micropores. The wicks 26z utilize capillary action to travel the condensed working fluid and the vaporized working fluid in the hollow portion 26b1, improving thermal conductivity and thermal equalization by thermal exchange.

The vapor chamber 26b is constructed of a substantially rectangular frame made of a material having an increased thermal conductivity, for example, copper, aluminum, silver, graphite, and the like. As illustrated in FIG. 4, the vapor chamber 26b further includes the slide-contact face 26b2 that is planar. The slide-contact face 26b2 directly contacts the inner circumferential face 21a of the fixing belt 21 that slides over the slide-contact face 26b2.

As illustrated in FIG. 4, the vapor chamber 26b according to the embodiment includes the slide-contact face 26b2 over which the fixing belt 21 slides. The slide-contact face 26b2 is made of a low friction material. For example, the slide-contact face 26b2 of the vapor chamber 26b includes a coating layer 26x. The coating layer 26x is thin film made of a low friction material such as fluororesin. The coating layer 26x decreases frictional resistance between the vapor chamber 26b and the fixing belt 21 that slides over the vapor chamber 26b, reducing abrasive degradation of the fixing belt 21 and the vapor chamber 26b. In order to attain the advantages described above, at least the slide-contact face 26b2 is made of the low friction material. Alternatively, other part of the vapor chamber 26b may also be made of the low friction material.

As illustrated in FIGS. 4 and 5, the vapor chamber 26b according to the embodiment further includes a plurality of pillars 26b10 that is disposed in the hollow portion 26b1 sealed with the working fluid. The pillars 26b10 bridge between the inner walls 26b4 and 26b5. The inner wall 26b4 is a nip side inner wall that is disposed in proximity to the fixing nip N. The inner wall 26b5 is a non-nip side inner wall that is disposed opposite the fixing nip N via the inner wall 26b4. The inner wall 26b5 is disposed opposite the inner wall 26b4 and is disposed in proximity to the reinforcement 23. For example, in the hollow portion 26b1 of the vapor chamber 26b, the plurality of pillars 26b10 is disposed in a space where the working fluid flows and is also disposed in a space defined from the nip side, inner wall 26b4 to the non-nip side, inner wall 26b5 such that the pillars 26b10 do not hinder thermal exchange by flow of the working fluid. According to the embodiment, the pillars 26b10 and the frame of the vapor chamber 26b are made of an identical material. The pillars 26b10 are combined with the frame of the vapor chamber 26b. Accordingly, although the vapor chamber 26b includes the hollow portion 26b1 and therefore has an insufficient mechanical strength, the pillars 26b10 suppress deformation of the vapor chamber 26b when the vapor chamber 26b receives pressure from the pressure roller 31. Hence, the vapor chamber 26b retains a proper shape of the fixing nip N, performing proper fixing stably and retaining proper thermal exchange.

A description is provided of a construction of a first comparative fixing device and a second comparative fixing device employing an electrophotographic method.

The first comparative fixing device includes a nip formation pad that contacts an inner circumferential face of a fixing rotator. The nip formation pad is made of metal such as copper and aluminum to enhance thermal conductivity of the nip formation pad.

The second comparative fixing device includes a nip formation pad including a hollow heat pipe sealed with working fluid. As the working fluid vaporizes and condenses repeatedly, the heat pipe enhances thermal conductivity thereof.

The first comparative fixing device further includes a support that contacts the nip formation pad thermally. After a plurality of sheets having a decreased size is conveyed through the first comparative fixing device, both lateral end spans of the fixing rotator in an axial direction thereof may suffer from temperature increase because the plurality of sheets does not draw heat from the lateral end spans of the fixing rotator. The support and the nip formation pad suppress temperature increase of the lateral end spans of the fixing rotator, attaining even temperature of the fixing rotator.

However, the nip formation pad of each of the first comparative fixing device and the second comparative fixing device, that has an enhanced thermal conductivity, may draw heat from the fixing rotator when the fixing rotator is warmed up. The nip formation pad may conduct heat to the support that supports the nip formation pad.

For example, FIG. 6 illustrates a fixing device 20A that includes a nip formation pad 26A employing a heat pipe, a reinforcement 23A, and a reflection plate 27A. Since the heat pipe has an enhanced thermal conductivity, the nip formation pad 26A may draw heat from the fixing belt 21 serving as the fixing rotator when the fixing device 20A is warmed up. Additionally, heat may escape to the reinforcement 23A that supports the nip formation pad 26A.

For example, FIG. 7 illustrates a fixing device 20B that includes a nip formation pad 26B made of metal. The nip formation pad 26B includes a component that couples and separates the reinforcement 23 (e.g., a stay) with respect to the nip formation pad 26B thermally, preventing temperature increase of both lateral end spans of the fixing belt 21 in the longitudinal direction thereof. When the fixing device 20B is warmed up, the fixing device 20B blocks the component that couples the reinforcement 23 with the nip formation pad 26B and separates the reinforcement 23 from the nip formation pad 26B thermally. However, the reinforcement 23 that supports the nip formation pad 26B contacts other component. Hence, the nip formation pad 26B may draw heat from the fixing belt 21. Additionally, heat may escape to the reinforcement 23 supporting the nip formation pad 26B.

For example, FIGS. 8 and 9 illustrate the fixing device 20 that includes the nip formation pad 26 employing the vapor chamber 26b. FIG. 8 is a cross-sectional view of the fixing device 20, illustrating an entirety thereof. FIG. 9 is a partial cross-sectional view of the fixing device 20. Since the vapor chamber 26b has an enhanced thermal conductivity, the nip formation pad 26 may draw heat from the fixing belt 21 when the fixing device 20 is warmed up. Additionally, heat may escape to the reinforcement 23 supporting the nip formation pad 26.

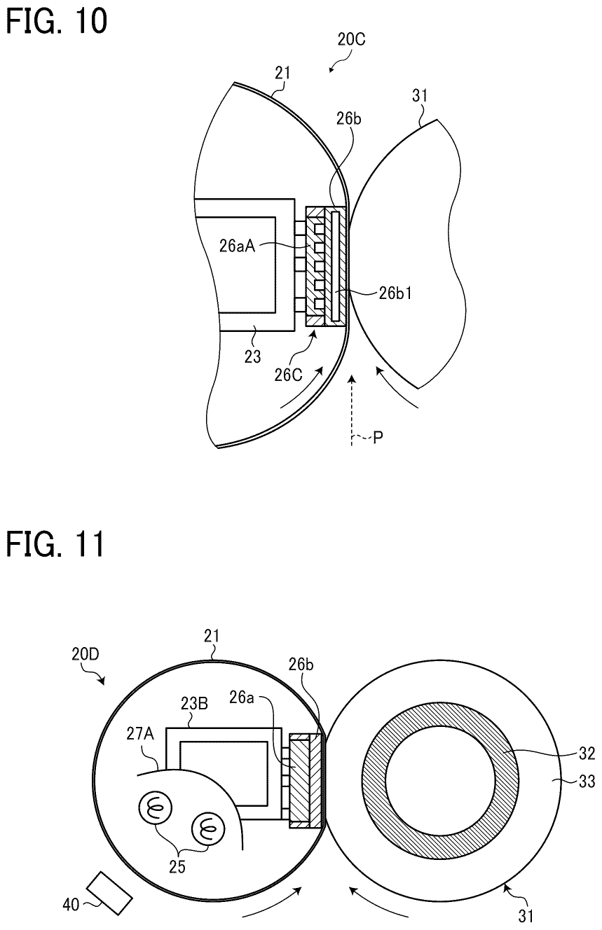

FIG. 10 illustrates a fixing device 20C as a modification example of the fixing device 20 depicted in FIGS. 8 and 9. The fixing device 20C includes a nip formation pad 26C including a support 26aA that supports the vapor chamber 26b. The support 26aA includes a contact portion that is uneven and is not planar. The contact portion decreases a contact area where the support 26aA contacts the vapor chamber 26b, suppressing heat that escapes. However, the contact portion of the support 26aA may suppress escape of heat insufficiently. Hence, the nip formation pad 26C may draw heat from the fixing belt 21 when the fixing device 20C is warmed up. Additionally, heat may escape to the reinforcement 23 supporting the nip formation pad 26C.

FIG. 11 illustrates a fixing device 20D that is substantially equivalent to the fixing device 20 depicted in FIG. 8. The fixing device 20D is different from the fixing device 20 in that the reflection plate 27A defines an aperture direction for the heaters 25, that is different from an aperture direction defined by the reflection plate 27 depicted in FIG. 8.

The following describes a construction according to an embodiment of the present disclosure based on the fixing device 20D depicted in FIG. 11.

The construction according to the embodiment is also applied to the fixing device 20 depicted in FIG. 8.

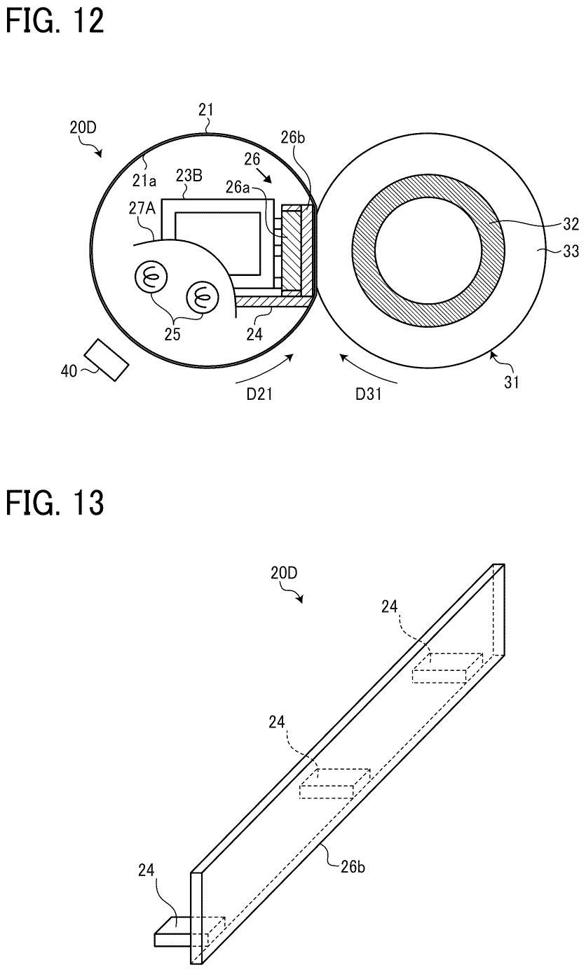

FIG. 12 is a cross-sectional view of the fixing device 20D according to the embodiment as one example. As illustrated in FIG. 12, the fixing device 20D according to the embodiment includes a conductor 24, the reflection plate 27A, and a reinforcement 23B. The conductor 24 is interposed between the vapor chamber 26b and the reflection plate 27A, coupling the vapor chamber 26b with the reflection plate 27A. The conductor 24 is one example of a thermal conductor that couples the vapor chamber 26b with the reflection plate 27A. Before the fixing device 20D is warmed up, components of the fixing device 20D have a room temperature. As warm-up of the fixing device 20D starts, the pressure roller 31 receives a driving force. As the pressure roller 31 rotates, the fixing belt 21 rotates in accordance with rotation of the pressure roller 31 at a predetermined speed. Simultaneously, the heaters 25 are energized and generate heat. While the fixing belt 21 rotates, the inner circumferential face 21a of the fixing belt 21 receives heat emitted from the heaters 25 and heat reflected by the reflection plate 27A. Accordingly, an entire circumference of the fixing belt 21 is heated to a target temperature. The nip formation pad 26 contacting the inner circumferential face 21a of the fixing belt 21 and the pressure roller 31 contacting the outer circumferential face of the fixing belt 21 draw heat from the fixing belt 21, delaying temperature increase of the fixing belt 21.

The fixing device 20D according to the embodiment decreases heat drawn by the nip formation pad 26 contacting the inner circumferential face 21a of the fixing belt 21 when the fixing device 20D is warmed up. The reflection plate 27A has a surface that reflects light and heat emitted by the heaters 25 readily. However, the reflection plate 27A receives heat from the heaters 25 disposed in proximity to the reflection plate 27A. Hence, a temperature of the reflection plate 27A increases faster than peripheral components also when the fixing device 20D is warmed up. With general configurations, heat conducted to the reflection plate 27A may dissipate naturally within the loop formed by the fixing belt 21 or may dissipate to a component that contacts the reflection plate 27A, such as the reinforcement 23B. According to the embodiment, the conductor 24 couples the reflection plate 27A with the vapor chamber 26b thermally, conducting heat from the reflection plate 27A to the vapor chamber 26b. Since the conductor 24 and the vapor chamber 26b have an enhanced thermal conductivity, heat is conducted from the reflection plate 27A to the vapor chamber 26b quickly and evenly. With general configurations, when the fixing device 20D is warmed up, the vapor chamber 26b may draw heat from the fixing belt 21. Conversely, in the fixing device 20D according to the embodiment depicted in FIG. 12, the vapor chamber 26b receives heat from the reflection plate 27A and is heated to an increased temperature quickly. Accordingly, conduction of heat from the fixing belt 21 to the vapor chamber 26b decreases. Consequently, the fixing belt 21 is heated to a predetermined temperature quickly, shortening the warm-up time.

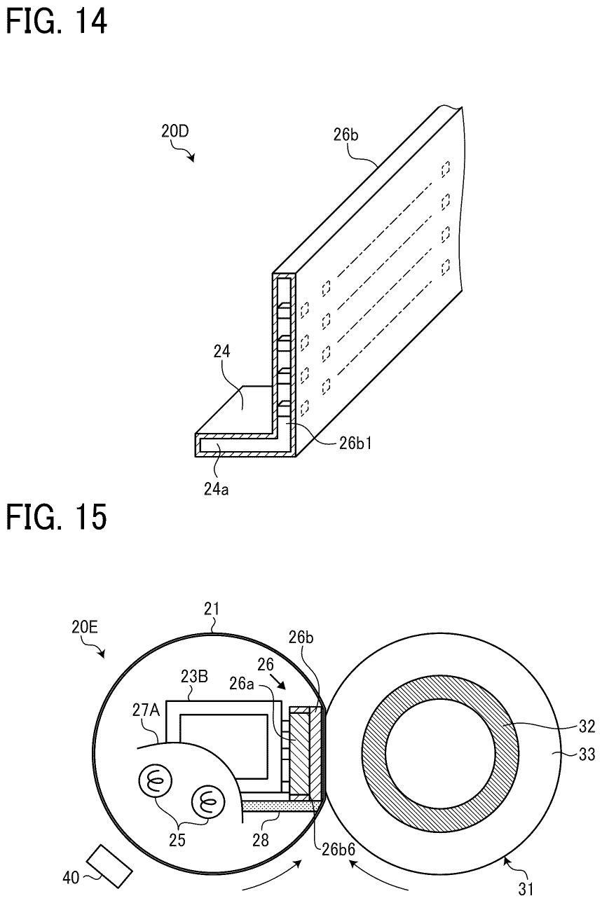

FIGS. 13 and 14 illustrate the fixing device 20D according to the embodiment as one example. FIG. 13 is a perspective view of the vapor chamber 26b and the conductors 24 incorporated in the fixing device 20D depicted in FIG. 12 as a cross-sectional view of the fixing device 20D as one example. As illustrated in FIG. 13, the vapor chamber 26b and the conductor 24 define an L-shaped bent portion at a bottom of the vapor chamber 26b. The conductor 24 depicted in FIG. 12 extends from a bottom part of the L-shaped bent portion horizontally in FIG. 12. The conductor 24 has a tip that contacts the reflection plate 27A. The conductor 24 is one example of a thermal conductor that is combined with the nip formation pad 26 into a unit.

FIG. 14 is a cross-sectional view of the vapor chamber 26b and the conductor 24 as one example. Since the vapor chamber 26b is combined with the conductor 24 into a unit, the hollow portion 26b1 of the vapor chamber 26b, that is sealed with the working fluid, communicates with a hollow portion 24a of the conductor 24. Thus, the conductor 24 contacting the reflection plate 27A serves as a thermal conductor sealed with the working fluid. The conductor 24 having the enhanced thermal conductivity couples the vapor chamber 26b with the reflection plate 27A thermally, shortening the warm-up time of the fixing device 20D and saving energy. FIG. 13 illustrates three conductors 24 disposed at three different positions, respectively. Alternatively, a number, a width, and a position of the conductor 24 may be modified arbitrarily as long as the conductor 24 contacts the reflection plate 27A.

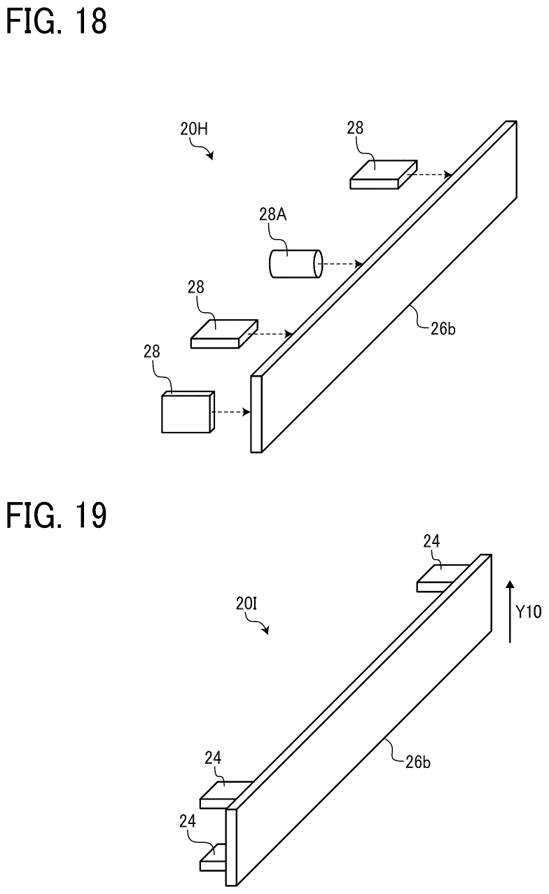

FIGS. 15 to 18 illustrate fixing devices 20E, 20F, 20G, and 20H according to embodiments of the present disclosure as one example. FIG. 18 is a schematic perspective view of the vapor chamber 26b and conductors 28 and 28A. As illustrated in FIG. 18, the conductors 28 and 28A are separate components that are not combined with the vapor chamber 26b. Each of the conductors 28 and 28A is one example of a thermal conductor that couples the vapor chamber 26b with the reflection plate 27 or 27A. Each of the conductors 28 and 28A and the nip formation pad 26 are formed as separate bodies, respectively. FIG. 15 illustrates the conductor 28 that abuts on a side face 26b6 of the vapor chamber 26b like the conductor 24 depicted in FIG. 12. The conductors 24 and 28 attain similar advantages. However, since the vapor chamber 26b and the conductor 28 are the separate components, respectively, the vapor chamber 26b is not treated with bending and does not have a complex shape, facilitating machining. The vapor chamber 26b has a simple shape, improving thermal conductivity and productivity of parts and reducing manufacturing costs of parts. However, the conductor 28 is installed in the fixing device 20E with an installation mechanism, a securing method, and the like that are properly selected.

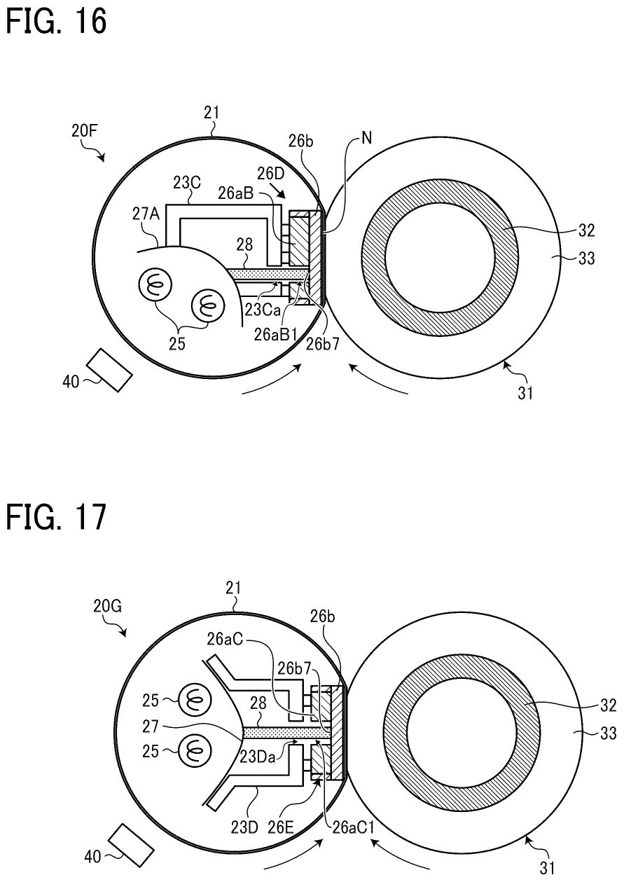

As illustrated in FIG. 16, the fixing device 20F includes a reinforcement 23C and a nip formation pad 26D that includes a support 26aB and the vapor chamber 26b. The conductor 28 contacts a back plane 26b7 of the vapor chamber 26b. The back plane 26b7 is opposite to the nip face of the vapor chamber 26b, that faces the fixing nip N. The conductor 28 contacts an opposed face of the reflection plate 27A, that is disposed opposite the back plane 26b7 via the conductor 28. Since the vapor chamber 26b has the enhanced thermal conductivity, even if the conductor 28 contacts any part of the vapor chamber 26b, heat is conducted from the conductor 28 to an entirety of the vapor chamber 26b quickly. Thus, the conductor 28 depicted in FIG. 16 attains thermal conduction like the conductor 28 depicted in FIG. 15. In order to position the conductor 28 and couple the vapor chamber 26b with the reflection plate 27A thermally, the support 26aB partially includes a slot 26aB1. The reinforcement 23C partially includes a slot 23Ca. The slots 26aB1 and 23Ca define a path through which the conductor 28 penetrates. The conductor 28 penetrating through the slots 26aB1 and 23Ca contacts the vapor chamber 26b and the reflection plate 27A, preventing heat from escaping to the support 26aB and the reinforcement 23C. In a case that the conductor 28 contacts a separate member that supports the conductor 28, the separate member is preferably made of a material or a configuration that has an enhanced thermal insulation and does not draw heat.

FIG. 17 illustrates the fixing device 20G that is similar to the fixing device 20F depicted in FIG. 16. For example, the fixing device 20G includes a nip formation pad 26E and a reinforcement 23D. The nip formation pad 26E includes a support 26aC and the vapor chamber 26b. The support 26aC includes a slot 26aC1. The reinforcement 23D includes a slot 23Da. The conductor 28 penetrates through the slots 26aC1 and 23Da. However, the fixing device 20G is different from the fixing device 20F in that the fixing device 20G incorporates the reflection plate 27 that defines the aperture direction for the heaters 25, that is different from the aperture direction of the reflection plate 27A of the fixing device 20F. The conductor 28 is preferably made of a material having an enhanced thermal conductivity and an enhanced heat resistance. For example, the conductor 28 is made of general metal such as a copper alloy and aluminum. Alternatively, the conductor 28 may be a machined component partially interposed between the nip formation pad 26E and the reflection plate 27.

FIG. 18 is a schematic perspective view of the fixing device 20H according to an embodiment of the present disclosure as one example. As illustrated in FIG. 18, the fixing device 20H includes the conductors 28 and 28A as the separate bodies, respectively, that are different and separated from the vapor chamber 26b. In order to attain advantages sufficiently, the conductors 28 and 28A preferably have an enhanced thermal conductivity. As the vapor chamber 26b, the fixing device 20H employs a vapor chamber, a heat pipe, or the like serving as a thermal conductor including a hollow portion sealed with the working fluid, thus achieving advantages. FIG. 18 illustrates the platy conductor 28 as the vapor chamber and the cylindrical conductor 28A as the heat pipe. Each of the conductors 28 and 28A is one example of a thermal conductor as a vapor chamber or a heat pipe that is made of a thermally conductive material and sealed with working fluid (e.g., a working agent).

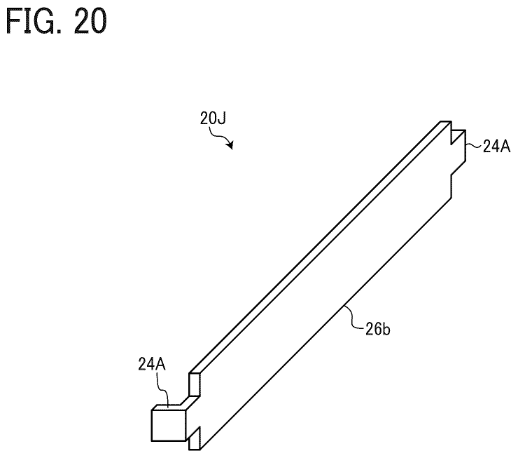

FIG. 13 is a partial schematic perspective view of the fixing device 20D including the vapor chamber 26b and the conductors 24. FIG. 18 is a partial schematic perspective view of the fixing device 20H including the vapor chamber 26b and the conductors 28 and 28A. FIG. 19 is a partial schematic perspective view of a fixing device 20I including the vapor chamber 26b and the conductors 24. FIG. 20 is a partial schematic perspective view of a fixing device 20J including the vapor chamber 26b and conductors 24A.

As illustrated in FIGS. 13, 18, 19, and 20, a number, a width, and a position of each of the conductors 24, 24A, 28, and 28A may be modified arbitrarily as long as each of the conductors 24, 24A, 28, and 28A couples the reflection plate 27 or 27A with the vapor chamber 26b.

FIG. 19 illustrates the conductors 24 that are combined with the vapor chamber 26b into a unit. The conductors 24 are disposed at an upstream end and a downstream end of the vapor chamber 26b, respectively, in the sheet conveyance direction Y10 in which the sheet P is conveyed.

FIG. 20 illustrates the conductors 24A that are combined with the vapor chamber 26b into a unit. The conductors 24A are disposed at both lateral ends of the vapor chamber 26b in a longitudinal direction of the vapor chamber 26b, respectively, that is parallel to a width direction of the sheet P.

The conductors 24 and 24A combined with the vapor chamber 26b and the conductors 28 and 28A have the enhanced thermal conductivity, thus thermally equalizing an entirety of the fixing belt 21 quickly. Hence, the conductors 24, 24A, 28, and 28A thermally couple the reflection plate 27 or 27A with the vapor chamber 26b partially at arbitrary positions, attaining thermal equalization of the fixing belt 21. As a result, the conductors 24, 24A, 28, and 28A shorten the warm-up time of the fixing devices 20, 20C, 20D, 20E, 20F, 20G, 20H, 20I, and 20J and improve energy saving. Alternatively, a conductor may extend throughout the entirety of the vapor chamber 26b in the width direction of the sheet P to couple the reflection plate 27 or 27A with the vapor chamber 26b thermally, attaining thermal equalization of the fixing belt 21 more quickly. Each of the conductors 24 and 24A is one example of a thermal conductor that is interposed between a nip formation pad (e.g., the nip formation pads 26, 26C, 26D, and 26E) and a reflection plate (e.g., the reflection plates 27 and 27A) and contacts the nip formation pad and the reflection plate partially.

FIG. 19 is a schematic perspective view of the vapor chamber 26b and the conductors 24. As illustrated in FIG. 19, the conductors 24 are disposed at the upstream end and the downstream end of the vapor chamber 26b in the sheet conveyance direction Y10 of the sheet P, respectively. Since the conductors 24 are disposed at the upstream end and the downstream end of the vapor chamber 26b in the sheet conveyance direction Y10, respectively, the conductors 24 sandwich the support 26a. Thus, the conductors 24 serve as a positioner that positions the vapor chamber 26b in the sheet conveyance direction Y10. Preferably, the fixing device 20I further includes a thermal insulator that has an enhanced thermal insulation. The thermal insulator is interposed between the conductor 24 and the support 26a and contacts the conductor 24 and the support 26a. The thermal insulator prevents heat loss.

A number of the conductors 24 disposed at the upstream end and the downstream end of the vapor chamber 26b in the sheet conveyance direction Y10 and at both lateral ends of the vapor chamber 26b in the width direction of the sheet P is arbitrary. As illustrated in FIG. 19, the conductors 24 disposed in proximity to both lateral edges of the vapor chamber 26b in the longitudinal direction thereof, that is, the width direction of the sheet P, position the support 26a stably.

FIG. 20 is a schematic perspective view of the vapor chamber 26b and the conductors 24A. As illustrated in FIG. 20, the conductors 24A are disposed at a right edge and a left edge of the vapor chamber 26b in FIG. 20 in the longitudinal direction thereof, respectively, that is, the width direction of the sheet P. Since the conductors 24A are disposed at both lateral edges of the vapor chamber 26b in the width direction of the sheet P, respectively, the conductors 24A sandwich the support 26a. Thus, the conductors 24A serve as a positioner that positions the vapor chamber 26b in the width direction of the sheet P. Preferably, the fixing device 20J further includes a thermal insulator that has an enhanced thermal insulation. The thermal insulator is interposed between the conductor 24A and the support 26a and contacts the conductor 24A and the support 26a. The thermal insulator prevents heat loss. The conductor 24A is one example of a thermal conductor that includes the positioner that positions the nip formation pad 26.

As described above, with an image forming apparatus (e.g., the image forming apparatus 1) and a fixing device (e.g., the fixing devices 20, 20C, 20D, 20E, 20F, 20G, 20H, 20I, and 20J) according to the embodiments, even in a case that the fixing device employs a nip formation pad (e.g., the nip formation pads 26, 26C, 26D, and 26E) including the vapor chamber 26b having the enhanced thermal conductivity, the nip formation pad utilizes heat conducted from a reflection plate (e.g., the reflection plates 27 and 27A) through a conductor (e.g., the conductors 24, 24A, 28, and 28A). Accordingly, the nip formation pad does not draw heat from the fixing belt 21, shortening the warm-up time of the fixing device and saving energy.

According to the embodiments, the technology of the present disclosure is applied to the fixing device employing the pressure roller 31 as the pressure rotator. Alternatively, the technology of the present disclosure may also be applied to a fixing device that employs a pressure belt as the pressure rotator. The fixing device employing the pressure belt also attains advantages similar to the advantages attained by the embodiments described above.

The technology of the present disclosure is not limited to the embodiments described above. The embodiments of the present disclosure are modified properly to configurations or constructions other than those suggested in the embodiments described above within the scope of the technology of the present disclosure. The number, the position, the shape, and the like of the elements and the components according to the embodiments of the present disclosure are not limited to those suggested in the embodiments described above and are modified to the number, the position, the shape, and the like that are appropriate to achieve the technology of the present disclosure.

According to the present disclosure, the width direction defines a direction perpendicular to the sheet conveyance directions Y10 and Y11 of the sheet P. The width direction is parallel to an axial direction of the fixing belt 21 and the pressure roller 31.

According to the embodiments described above, the image forming apparatus 1 applied with the technology of the present disclosure is a printer. Alternatively, the technology of the present disclosure is also applied to an image forming apparatus such as a multifunction peripheral (MFP) having at least two of copying, printing, scanning, and facsimile functions, a copier, a scanner, and a facsimile machine.

A description is provided of aspects of the embodiments of the present disclosure.

A description is provided of a first aspect of the embodiments of the present disclosure.

A fixing device (e.g., the fixing devices 20, 20C, 20D, 20E, 20F, 20G, 20H, 20I, and 20J) includes a fixing belt (e.g., the fixing belt 21), a pressure rotator (e.g., the pressure roller 31), a heater (e.g., the heater 25), a nip formation pad (e.g., the nip formation pads 26, 26C, 26D, and 26E), a reinforcement (e.g., the reinforcements 23, 23B, 23C, and 23D), a reflection plate (e.g., the reflection plates 27 and 27A), and a thermal conductor (e.g., the conductors 24, 24A, 28, and 28A).

The fixing belt is endless and rotates in a rotation direction (e.g., the rotation direction D21). The pressure rotator is disposed opposite the fixing belt and rotates in a rotation direction (e.g., the rotation direction D31). The heater is disposed within a loop formed by the fixing belt. The heater heats the fixing belt. The nip formation pad is disposed within the loop formed by the fixing belt. The nip formation pad is disposed opposite the pressure rotator via the fixing belt to form a nip (e.g., the fixing nip N) between the fixing belt and the pressure rotator. The nip formation pad includes a vapor chamber (e.g., the vapor chamber 26b). The reinforcement is disposed within the loop formed by the fixing belt. The reinforcement supports the nip formation pad. The reflection plate is interposed between the heater and the reinforcement. The reflection plate reflects heat from the heater toward the fixing belt. The thermal conductor couples the vapor chamber of the nip formation pad with the reflection plate.

A description is provided of a second aspect of the embodiments of the present disclosure.

In the fixing device according to the first aspect, the thermal conductor is combined with the nip formation pad into a unit.

A description is provided of a third aspect of the embodiments of the present disclosure.

In the fixing device according to the first aspect, the thermal conductor and the nip formation pad are formed as separate bodies, respectively.

A description is provided of a fourth aspect of the embodiments of the present disclosure.

In the fixing device according to the third aspect, the thermal conductor is a vapor chamber or a heat pipe that is made of a thermally conductive material and sealed with a working agent.

A description is provided of a fifth aspect of the embodiments of the present disclosure.

In the fixing device according to any one of the first aspect to the fourth aspect, the thermal conductor is interposed between the nip formation pad and the reflection plate and contacts a part of each of the nip formation pad and the reflection plate.

A description is provided of a sixth aspect of the embodiments of the present disclosure.

In the fixing device according to the second aspect, the thermal conductor positions the nip formation pad. For example, at least two thermal conductors position the nip formation pad.

A description is provided of a seventh aspect of the embodiments of the present disclosure.

An image forming apparatus (e.g., the image forming apparatus 1) includes the fixing device according to any one of the first aspect to the sixth aspect.

With the fixing device and the image forming apparatus described above, even in a case that the fixing device employs the nip formation pad including the vapor chamber having an enhanced thermal conductivity, the nip formation pad utilizes heat conducted from the reflection plate through the thermal conductor. Accordingly, the nip formation pad does not draw heat from the fixing belt, shortening the warm-up time of the fixing device and saving energy.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A fixing device comprising:
a fixing belt that is endless, the fixing belt to rotate;
a pressure rotator disposed opposite the fixing belt, the pressure rotator to rotate;
a heater disposed within a loop formed by the fixing belt, the heater to heat the fixing belt;
a nip formation pad disposed opposite the pressure rotator via the fixing belt to form a nip between the fixing belt and the pressure rotator, the nip formation pad including a vapor chamber;
a reinforcement disposed within the loop formed by the fixing belt, the reinforcement supporting the nip formation pad;
a reflection plate interposed between the heater and the reinforcement, the reflection plate to reflect heat from the heater toward the fixing belt; and
a thermal conductor coupling the reflection plate with the vapor chamber of the nip formation pad.

2. The fixing device according to claim 1,
wherein the thermal conductor is combined with the nip formation pad into a unit.

3. The fixing device according to claim 2, further comprising another thermal conductor,
wherein the thermal conductor and said another thermal conductor position the nip formation pad.

4. The fixing device according to claim 3,
wherein the nip formation pad further includes a support supporting the vapor chamber.

5. The fixing device according to claim 4,
wherein the thermal conductor is disposed at an upstream end of the vapor chamber in a recording medium conveyance direction in which a recording medium is conveyed through the nip.

6. The fixing device according to claim 5,
wherein said another thermal conductor is disposed at a downstream end of the vapor chamber in the recording medium conveyance direction, and
wherein the thermal conductor and said another thermal conductor sandwich the support of the nip formation pad.

7. The fixing device according to claim 4,
wherein the thermal conductor is disposed at one lateral end of the vapor chamber in a longitudinal direction of the vapor chamber,
wherein said another thermal conductor is disposed at another lateral end of the vapor chamber in the longitudinal direction of the vapor chamber, and
wherein the thermal conductor and said another thermal conductor sandwich the support of the nip formation pad.

8. The fixing device according to claim 1,
wherein the thermal conductor and the nip formation pad are formed as separate bodies, respectively.

9. The fixing device according to claim 8,
wherein the thermal conductor includes a vapor chamber that includes a thermally conductive material and is sealed with a working agent.

10. The fixing device according to claim 8,
wherein the thermal conductor includes a heat pipe that includes a thermally conductive material and is sealed with a working agent.

11. The fixing device according to claim 8,
wherein the nip formation pad further includes a support supporting the vapor chamber.

12. The fixing device according to claim 11,
wherein the vapor chamber has a side face contacting the thermal conductor.

13. The fixing device according to claim 11,
wherein the vapor chamber includes a back plane contacting the thermal conductor, the back plane being disposed opposite the reflection plate via the thermal conductor.

14. The fixing device according to claim 13,
wherein the reinforcement includes a first slot,
wherein the support includes a second slot, and
wherein the thermal conductor penetrates through the first slot and the second slot.

15. The fixing device according to claim 1,
wherein the thermal conductor is interposed between the nip formation pad and the reflection plate and contacts a part of each of the nip formation pad and the reflection plate.

16. The fixing device according to claim 1,
wherein the pressure rotator includes a pressure roller.

17. A fixing device comprising:
fixing means for being rotated;
pressing means for being rotated;
heating means for heating the fixing means;
nip forming means for forming a nip between the fixing means and the pressing means, the nip forming means including a vapor chamber;
reinforcing means for supporting the nip forming means;
reflecting means for reflecting heat from the heating means toward the fixing means; and
thermal conducting means for conducting heat from the reflecting means to the vapor chamber of the nip forming means.

18. An image forming apparatus comprising:
an image forming device to form an image; and
a fixing device to fix the image on a recording medium,
the fixing device including:
a fixing belt that is endless, the fixing belt to rotate;
a pressure rotator disposed opposite the fixing belt, the pressure rotator to rotate;
a heater disposed within a loop formed by the fixing belt, the heater to heat the fixing belt;
a nip formation pad disposed opposite the pressure rotator via the fixing belt to form a nip between the fixing belt and the pressure rotator, the nip formation pad including a vapor chamber;
a reinforcement disposed within the loop formed by the fixing belt, the reinforcement supporting the nip formation pad;
a reflection plate interposed between the heater and the reinforcement, the reflection plate to reflect heat from the heater toward the fixing belt; and
a thermal conductor coupling the reflection plate with the vapor chamber of the nip formation pad.
